(19) United States
(12) Patent Application Publication
(10) Pub. No.: US 2007/0242636 A1
(43) Pub. Date: Oct. 18, 2007

(54) Apparatus, method and computer program product providing efficient and flexible control signal for resource allocation

(75) Inventors: Tsuyoshi Kashima, Yokohama (JP); Olav Tirkkonen, Helsinki (FI); Sigit Jarot, Yokohama (JP); Jussi Kahtava, Tokyo-to (JP)

Correspondence Address: HARRINGTON & SMITH, PC, 4 RESEARCH DRIVE, SHELTON, CT, 06484-6212, US

(73) Assignee: Nokia Corporation

(21) Appl. No.: 11/787,172

(22) Filed: Apr. 13, 2007

Related U.S. Application Data
(60) Provisional application No. 60/791,662, filed on Apr. 13, 2006.

(51) Int. Cl. H04Q 7/00

(52) U.S. Cl. 370/329

(57) ABSTRACT

A number N physical resource blocks PRBs are allocated among M users in a single control signal, in which some PRBs are allocated as localized to only one user UE and some PRBs are allocated as distributed among multiple UEs. The control signal includes M allocation entries, allocation type bits and a user index sequence of N user indexes. Each allocation entry comprises a UE-ID for indicating to which user a corresponding resource is allocated, where an order of the allocation entries indicates a relationship between the user index and the UE-ID. Individual ones of the allocation type bits corresponds to an individual one of the UE index. The allocation type bits indicate whether a corresponding UE is to use localized allocation or distributed allocation.

### CROSS REFERENCE TO RELATED APPLICATION

This application claims priority to U.S. Provisional Patent Application No. 60/791,662, filed on Apr. 13, 2006. That application, including Exhibits, is hereby incorporated by reference in its entirety. Exhibit B of that provisional application was itself a U.S. provisional patent application that has been filed as U.S. patent application Ser. No. 11/486,834 (filed on Mar. 20, 2007) and PCT/IB2007/000500 (filed on Mar. 1, 2007).

### TECHNICAL FIELD

The exemplary and non-limiting embodiments of this invention relate generally to wireless communications systems, devices, methods and computer program products and, more specifically, relate to resource allocation for a wireless user equipment.

### BACKGROUND

The following abbreviations are defined as follows:
3GPP third generation partnership project
C-RNTI cell radio network temporary identifier
DL downlink (Node B to UE)
FDM frequency division multiplexing
A-FDM adjacent frequency division multiplexing
F-FDM flexible frequency division multiplexing
HARQ hybrid auto-repeat request
LTE long term evolution
Node-B base station
OFDM orthogonal frequency division multiplex
PRB physical resource block
RB resource block
RNC radio network control
RNTI radio network temporary identity
SFN system frame number
TFI transport format indicator
UE user equipment
UL uplink (UE to Node B)
UMTS universal mobile telecommunications system
UTRAN UMTS terrestrial radio access network
E-UTRAN evolved UTRAN
VRB virtual resource block
L-VRB localized VRB
D-VRB distributed VRB

Flexible radio resource sharing between different data transmission is important in order to achieve a high performance and high throughput communication. As a result, a flexible resource allocation scheme is required in order to achieve a high performance and high throughput communication system. However, in order to reduce the overhead of control signaling, the structure of the DL control signal for resource allocation should be carefully considered. Thus, what is needed is a signaling scheme that provides flexible resource allocation with a low control signal overhead.

One previous proposal (3GPP R1-060777, “Distributed FDMA Transmission for Shared Data Channel in E-UTRA Downlink, 27-31 Mar. 2006 (attached as Exhibit A to the priority document U.S. Provisional Patent Application No. 60/791,662) discusses the use of RB-level distributed transmission. RB-level distributed transmission is said to be advantageous in achieving simple multiplexing with localized transmission, as well as for reducing the signaling overhead since the resource allocation of distributed transmission UEs does not affect the resource allocation of localized transmission UEs. It is demonstrated that the achievable throughput between the RB-level and sub-carrier-level distributed transmissions, considering hybrid ARQ with packet combining in the E-UTRA downlink. FIG. 7 of this document, reproduced herein as FIG. 1, shows an example of a DL control signaling format with RB-level distributed transmission.

The two approaches that are considered in that referenced Exhibit A is follows:

Approach 1: Inform the number of D-VRBs

Since the relationship between the used PRB index and D-VRB indices is only dependent on the number of D-VRBs, after the number of D-VRBs is known to the UEs, all the UEs can know which PRB should be decoded from the assigned VRB indices.

Approach 2: Inform the resource assignment type

From another point of view, the relationship between the PRB index and D-VRB indices can be identified if the UE can identify the assigned VRB as localized or distributed.

FIG. 1 herein shows examples of the downlink control signaling format for radio resource assignment for Approaches 1 and 2, respectively. It is assumed that the resource assignment information is jointly coded among multiple UEs to which radio resources are assigned (3GPP, R1-051331, Motorola, “E-UTRA Downlink Control Channel Design and TP”, and 3GPP, R1-060032, NTT DoCoMo, et al, “L1/L2 Control Channel Structure for E-UTRA Downlink”) and that a “table based approach” (3GPP, R1-060573, Ericsson, NTT DoCoMo, “E-UTRA Downlink Control Signaling-Overhead Assessment”) is used for the joint radio resource assignment. Approaches 1 and 2 are said to be also applicable to separated radio resource assignment control signaling to different UEs. In general, when joint coding is used, Approach 1 is said to be more attractive because the information regarding the number of D-VRBs used in this approach is common to all UEs. On the other hand, Approach 2 is said to be more appropriate for the separated coding of the control information regarding the radio resource assignment since only one additional bit is required for each UE.

The inventors have realized that the foregoing proposal exhibits a problem at least in terms of scheduling flexibility, as it assumes in both approaches apre-agreed way to construct a VRB (allocation block) when the number of distributed users is given.

### SUMMARY

In accordance with one embodiment of the invention is a method that comprises determining an allocation of N physical resource blocks among M users, including which physical resource blocks are allocated as localized and which are allocated as distributed. Further in the method, a control signal is wirelessly sent that informs the determined allocation, the control signal comprising M allocation entries, allocation type bits and a user index sequence of N user indexes. In that control signal, an allocation entry includes a user identifier for indicating to which user a corresponding resource is allocated, an order of the allocation entries indicates a relationship between the user index and the user identifier, individual ones of the allocation type bits corresponds to an individual one of the user index, and the allocation type bits indicate whether a corresponding user is to use localized allocation or distributed allocation.

In accordance with another embodiment of the invention is a computer program product, tangibly embodied on a memory, and including instructions for allocating resource blocks to users. When the instructions are executed by a processor the actions taken include determining an allocation of N physical resource blocks among M users, including which physical resource blocks are allocated as localized and which are allocated as distributed. Further, the actions then include wirelessly sending a control signal that informs the determined allocation. The control signal includes M allocation entries, allocation type bits and a user index sequence of N user indexes. An allocation entry includes a user identifier for indicating to which user a corresponding resource is allocated, and an order of the allocation entries indicates a relationship between the user index and the user identifier. Individual ones of the allocation type bits corresponds to an individual one of the user index. The allocation type bits indicate whether a corresponding user is to use localized allocation or distributed allocation.

In accordance with another embodiment of the invention is a device that includes a a memory, a processor and a transceiver. The memory is adapted to stored user identifiers for each of M users. The processor includes a packet scheduler function for making an allocation of N physical resource blocks among the M users, including which physical resource blocks are allocated as localized and which are allocated as distributed. The transceiver is coupled to the processor, and is adapted to wirelessly send a control signal that informs the allocation. The control signal includes M allocation entries, allocation type bits and a user index sequence of N user indexes. Each of the allocation entries include one of the user identifiers for indicating to which user a corresponding resource is allocated, and an order of the allocation entries indicates a relationship between the user index and the user identifier. Individual ones of the allocation type bits corresponds to an individual one of the user index, and the allocation type bits indicate whether a corresponding user is to use localized allocation or distributed allocation.

In accordance with another embodiment of the invention is a device that comprises a means for determining an allocation of N physical resource blocks among M users, including which physical resource blocks are allocated as localized and which are allocated as distributed. The device also comprises a means for wirelessly sending a control signal that informs the determined allocation. The control signal includes M allocation entries, allocation type bits and a user index sequence of N user indexes. Each allocation entry includes a user identifier for indicating to which user a corresponding resource is allocated, and an order of the allocation entries indicates a relationship between the user index and the user identifier. Individual ones of the allocation type bits corresponds to an individual one of the UE index. And the allocation type bits indicate whether a corresponding user is to use localized allocation or distributed allocation. In a particular embodiment, the means for determining comprises a processor that includes a packet scheduler function coupled to a memory, and also in this particular embodiment the means for wirelessly sending comprises a transceiver.

In accordance with another embodiment of the invention is an integrated circuit that includes circuitry adapted to determine an allocation of N physical resource blocks among M users, including which physical resource blocks are allocated as localized and which are allocated as distributed. The integrated circuit further includes circuitry adapted to arrange and to wirelessly send a control signal that informs the determined allocation. The control signal includes M allocation entries, allocation type bits and a user index sequence of N user indexes. In the control signal, an allocation entry includes a user identifier for indicating to which user a corresponding resource is allocated; an order of the allocation entries indicates a relationship between the user index and the user identifier; individual ones of the allocation type bits corresponds to an individual one of the user index; and the allocation type bits indicate whether a corresponding user is to use localized allocation or distributed allocation.

In another embodiment of the invention is a system that includes a network element and a plurality of M user equipments. The network element includes a memory adapted to stored user identifiers for each of M user equipments, a processor comprising a packet scheduler function for making an allocation of N physical resource blocks among the M user equipments, including which physical resource blocks are allocated as localized and which are allocated as distributed, and a transceiver, coupled to the processor, adapted to wirelessly send a control signal that informs the allocation. The control signal includes M allocation entries, allocation type bits and a user index sequence of N user indexes, where N and M are each integers greater than one and N is equal to or greater than M. In the control signal, each allocation entry includes one of the user identifiers for indicating to which user equipment a corresponding resource is allocated, and an order of the allocation entries indicates a relationship between the user index and the user identifier. Individual ones of the allocation type bits in the control signal corresponds to an individual one of the user index, and the allocation type bits indicate whether a corresponding user is to use localized allocation or distributed allocation. Further in the system are M user equipments, each including a memory adapted to stored an Mth user identifier assigned to the user equipment, a transceiver adapted to wirelessly receive the control signal, and a processor adapted to determine from the control signal the allocation for the Mth user equipment. The determined allocation for the Mth user includes a resource allocated to the Mth user equipment and whether the resource allocated is localized or distributed. The processor of each Mth user equipment is further adapted to control the transceiver to monitor the resource allocated to the Mth user equipment for the case where the resource allocation is a downlink allocation, and to transmit on the resource allocated to the Mth user equipment for the case where the resource allocation is an uplink allocation.

### BRIEF DESCRIPTION OF THE DRAWINGS

Embodiments of the invention are described with reference to the attached Drawing Figures.

FIG. 1 shows an example of a previously proposed downlink control signaling format with RB-level distributed transmission for two different approaches for (a) informing the number of D-VRBs and (b) informing the resource assignment type.

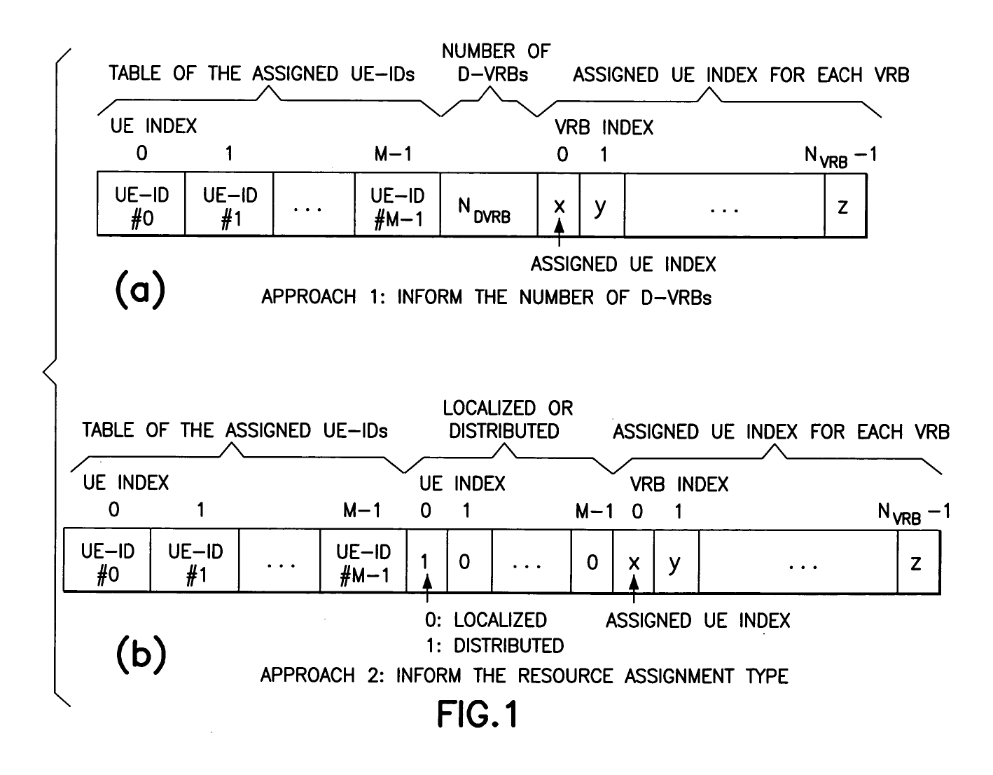

FIG. 2 shows a simplified block diagram of various electronic devices that are suitable for use in practicing the exemplary embodiments of this invention.

FIG. 3 depicts the general structure and format of a DL control signal for DL resource allocation in accordance with the exemplary embodiments of this invention.

FIG. 4 shows examples of DL resource allocation for a cyclic distribution and for a sub-carrier division distribution in accordance with the exemplary embodiments of this invention.

FIG. 5 is a process flow diagram showing method steps for performing an embodiment of the invention.

### DETAILED DESCRIPTION

The exemplary embodiments of this invention provide a novel control signal structure for DL resource allocation that is well suited for use in, but is not specifically limited to, the E-UTRAN system. The exemplary embodiments of this invention provide the novel control signal structure that enables the flexible scheduling of both distributed and localized allocations in the same sub-frame. In terms of the localized allocation, and as an example, both A-FDM and F-FDM, which uses multiple localized allocations for one UE, may be supported.

Before discussing the exemplary embodiments of this invention in further detail, it is noted that commonly owned U.S. patent application Ser. No. 11/486,834, filed on Mar. 20, 2007, “Amended Control for Resource Allocation in a Radio Access Network”, by Tsuyoshi Kashima and Sigit Jarot (of which its priority U.S. provisional patent application filed on Mar. 20, 2006 was attached as Exhibit B to the priority document of this application, U.S. Provisional Patent Application No. 60/791,662), provides a technique to multiplex the distributed allocation and the localized allocation. An aspect of this approach may be referred to as a cyclic-type of distribution. For example, signaling can be further reduced in an embodiment where, in an allocation step in the case of distributed-allocation, includes cyclically allocating a sub-carrier block in consecutive symbol-duration time spans to the set of terminal devices (e.g., to UEs). By including the cyclic distributed allocation in system specifications, terminal devices as well as a network node performing the allocation will assume the cyclic allocation of resource blocks in consecutive symbol-duration time spans so that, even for the case of distributed allocation, no further signaling needs to be included in an allocation-table header. This further increases the ability to dynamically control the resource allocation during network operation. In further exemplary embodiments, the allocation step, in the case of the distributed-allocation type, includes allocating a plurality of resource blocks. Distributed allocation to the set of terminal devices is in this embodiment performed cyclically over the plurality of resource blocks and the group of consecutive spans in the cyclic allocation. The transmission resources are partitioned into sub-bands in the frequency domain. The allocating step is performed for each sub-band separately.

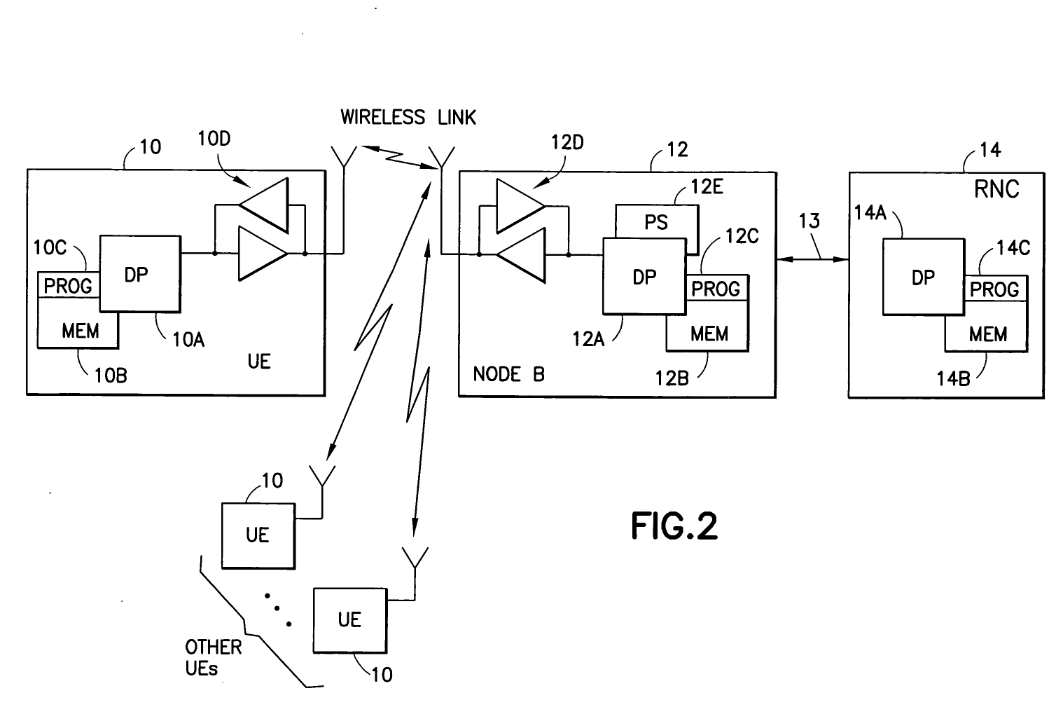

Reference is now made to FIG. 2 for illustrating a simplified block diagram of various electronic devices that are suitable for use in practicing the exemplary embodiments of this invention. In FIG. 2 a wireless network 1 is adapted for communication with a UE 10 via a Node B (base station) 12. There will typically be a plurality of UEs 10. The network 1 may include a control element, such as a RNC 14, which may be referred to as a serving RNC (SRNC). The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the RNC 14 that also includes a DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail. For example, the Node B may include a Packet Scheduler (PS) function 12E that operates in accordance with the exemplary embodiments of this invention to make localized and distributed allocations, as discussed in detail below. In addition, it is assumed that the UEs 10 are constructed and programmed to respond to the localized and distributed allocations that are received on the DL from the Node B.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The concept of the PRB and VRB are defined in 3GPP TR 25.814, V1.2.2 (2006-3), entitled “Physical Layer Aspects for Evolved UTRA” (incorporated by reference herein as needed), for example in Section 7.1.1.2.1 “Downlink data multiplexing” (attached as Exhibit C to the priority document U.S. Provisional Patent Application Ser. No. 60/791,662). As is stated, the channel-coded, interleaved, and data-modulated information [Layer 3 information] is mapped onto OFDM time/frequency symbols. The OFDM symbols can be organized into a number of physical resource blocks (PRB) consisting of a number (M) of consecutive sub-carriers for a number (N) of consecutive OFDM symbols. The granularity of the resource allocation should be able to be matched to the expected minimum payload. It also needs to take channel adaptation in the frequency domain into account. The size of the baseline physical resource block, S_{PRB}, is equal to M×N, where M=25 and N is equal to the number of OFDM symbols in a subframe (the presence of reference symbols or control information is ignored here to simplify the description). This results in the segmentation of the transmit bandwidth shown in Table 7.1.1.2.1-1 of 3GPP TR 25.814, reproduced below.

TABLE 7.1.1.2.1-1
Physical resource block bandwidth and number of
physical resource blocks dependent on bandwidth.

| | Bandwidth (MHz) | | | | | |
|---|---|---|---|---|---|---|
| | 1.25 | 2.5 | 5.0 | 10.0 | 15.0 | 20.0 |
| Physical resource block | 375 | 375 | 375 | 375 | 375 | 375 |
| bandwidth (kHz) | | | | | | |
| Number of available | 3 | 6 | 12 | 24 | 36 | 48 |
| physical resource blocks | | | | | | |

Using other values such as, e.g., M=15 or M=12 or M=10 or M equal to other values, may be considered based on the outcome of an interference coordination study.

The frequency and time allocations to map information for a certain UE to resource blocks is determined by the Node B scheduler and may, for example, depend on the frequency-selective CQI (channel-quality indication) reported by the UE to the Node B, see Section 7.1.2.1 (time/frequency-domain channel-dependent scheduling). The channel-coding rate and the modulation scheme (possibly different for different resource blocks) are also determined by the Node B scheduler and may also depend on the reported CQI (time/frequency-domain link adaptation).

Both block-wise transmission (localized) and transmission on non-consecutive (scattered, distributed) sub-carriers are also to be supported as a means to maximize frequency diversity. To describe this, the notion of a virtual resource block (VRB) is introduced. A virtual resource block has the following attributes:
Size, measured in terms of time-frequency resource.
Type, which can be either ‘localized’ or ‘distributed’.

All localized VRBs are of the same size, which is denoted as S_{VL}. The size S_{VD} of a distributed VRB may be different from S_{VL}. The relationship between S_{PRB}, S_{VL} and S_{VD} is reserved for future study.

Distributed VRBs are mapped onto the PRBs in a distributed manner. Localized VRBs are mapped onto the PRBs in a localized manner. The exact rules for mapping VRBs to PRBs are currently reserved for future study.

The multiplexing of localized and distributed transmissions within one subframe is accomplished by FDM.

As a result of mapping VRBs to PRBs, the transmit bandwidth is structured into a combination of localized and distributed transmissions. Whether this structuring is allowed to vary in a semi-static or dynamic (i.e., per sub-frame) way is said to be reserved for future study FFS. The UE can be assigned multiple VRBs by the scheduler. The information required by the UE to correctly identify its resource allocation must be made available to the UE by the scheduler. The number of signalling bits required to support the multiplexing of localized and distributed transmissions should be optimized.

The details of the multiplexing of lower-layer control signaling is said currently to be determined in the future, but may be based on time, frequency, and/or code multiplexing.

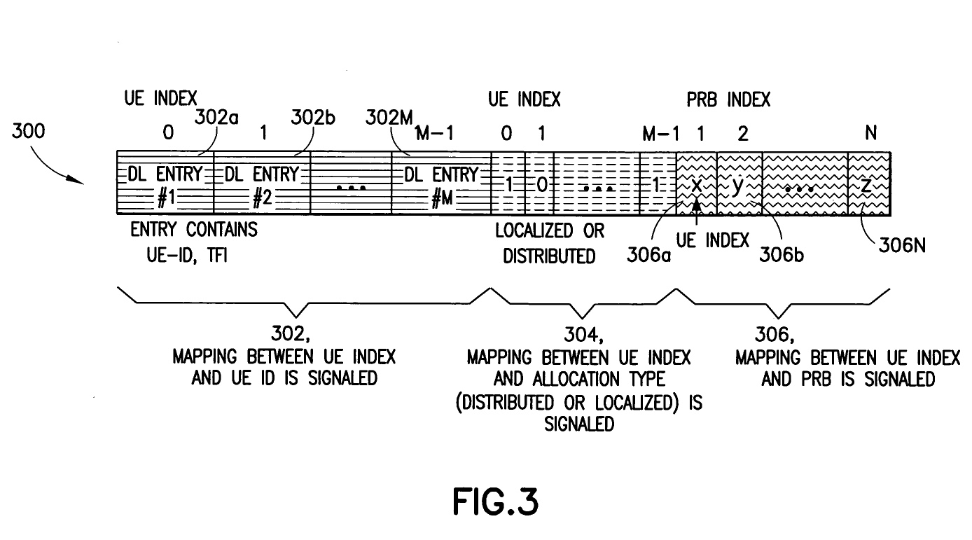

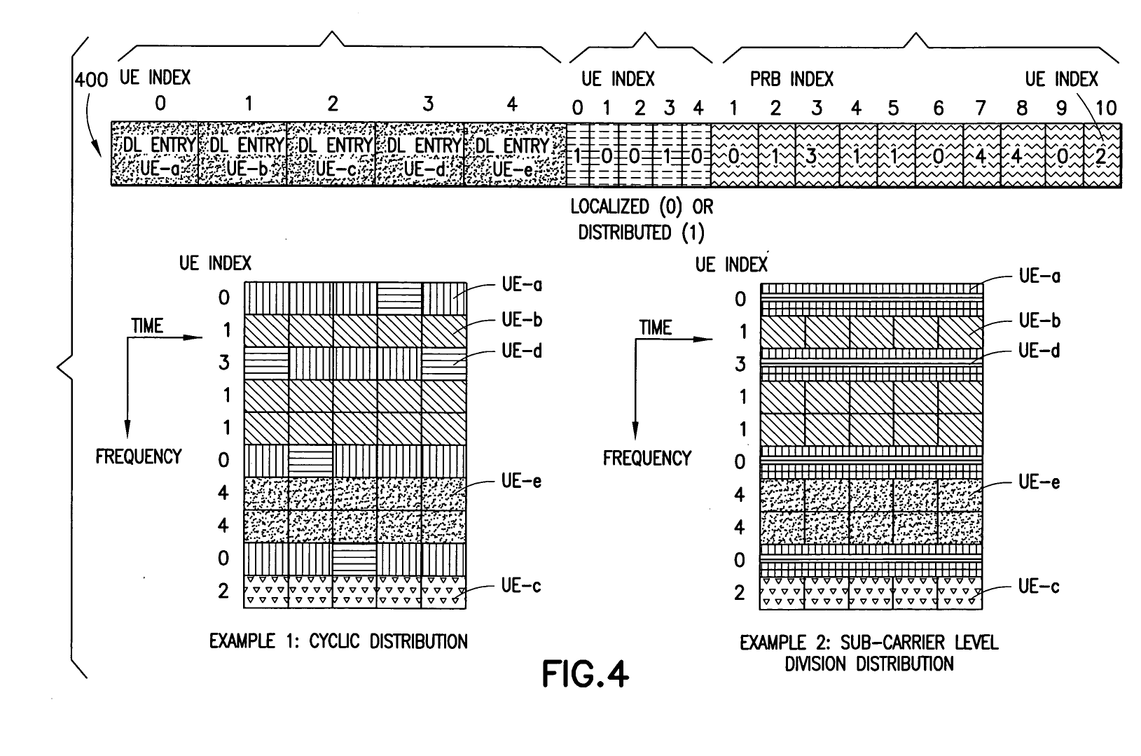

In accordance with the exemplary embodiments of this invention, and referring as well to FIGS. 3 and 4, the following assumptions are made and operations are performed for signaling the allocation of a set of resources to a number of UEs 10 during an allocation period.

A DL control signal 300 for DL resource allocation has at least one allocation entry 302a, 302b, . . . 302M, allocation type bits 304, and UE index sequence 306. These three components of the DL control signal may be transmitted jointly or separately.

The above-mentioned allocation entry has a UE-ID such as, but not limited to, C-RNTI, and possibly TFI, and HARQ control signals, and other information pertinent for the UE 10 such as power control information, information describing the length of the allocation, and so on. UE-ID indicates to which UE 10 the corresponding resource is allocated, TFI indicates what transport format is used in the allocated resource, and the HARQ control signal delivers the necessary HARQ information for the transmission in the allocated resource.

The set of allocation entries 302 imply a matching between UE indexes and the UE (UE-ID). For example, the order of the allocation entries may directly indicate the matching. Namely, the “UE index=0” is associated with the UE 10 in the first allocation entry 302a, the “UE index=1” is associated with the UE 10 in the second allocation entry 302b, and so forth.

Each bit of the above-mentioned allocation type bits 304 corresponds to each UE index. The allocation type bits 304 indicate whether the UE 10 uses localized allocation or distributed allocation.

UE 10 indexes 306a, 306b, . . . , 306N in the above-mentioned UE index sequence 306 correspond to PRBs. This UE index 306a, 306b, . . . , 306N indicates which UE or which UEs use which PRB.

For the localized allocation case, only one UE 10 uses one PRB. The PRBs that are used for localized allocation are those that are mapped to UE indexes with the corresponding allocation type bit 304 indicating localized allocation. A localized VRB of a certain UE index is constructed from the localized PRBs mapped to this UE index.

For the distributed allocation case, multiple UEs may use a given PRB. The PRB(s) that are used for distributed allocation are the ones that are mapped to UE indexes with the corresponding allocation type bit indicating distributed allocation. These may be referred to as the distributed PRBs. Different from the localized allocation case, a distributed VRB of a certain UE index is constructed from all or some of the distributed PRBs. The distributed PRBs are divided among the distributed VRBs in a pre-determined manner. This mapping need not be signaled. For example, a cyclic-type distribution, as discussed in “Amended Control for Resource Allocation in a Radio Access Network”, by Tsuyoshi Kashima and Sigit Jarot (Appendix B of the incorporated U.S. Provisional Patent Application No. 60/791,662), may be used as the pre-determined distribution method. As another non-limiting example, sub-carrier level division of PRBs, such as the one proposed in R1-060777 (Exhibit A of that incorporated provisional application), may be used.

The distributed VRBs are divided among the distributed UEs in an order that is determined by the order that the indexes of the distributed UEs appear in the UE index sequence. For the example of the cyclic-type division, the UE receiving the first TDM part in each PRB is indicated.

FIG. 4 shows a more detailed example with a control signal 400 that includes M=5 UEs in the allocation entry set 402, one localized or distributed indicator for each of those five UEs in a corresponding position of the allocation entry bit field 404, and N=10 PRBs allocated in the UE index sequence 406. Note that the allocation type bits 404 at positions corresponding to the UE index zero and three are distributed. Consulting the allocation entry field in the corresponding order shows that UE-a and UE-d are the ones given the distributed allocation. Cross referencing the UE index sequence 406, we see that UE-a (UE index=0) is allocated PRB 1, 6 and 9, whereas UE-d (UE index=3) is allocated PRB 3.

At each of the cyclic and sub-carrier level distributions of FIG. 4, rows indicate PRB in the order of PRB index. PRBs 1, 6 and 9 were allocated to UE-a, but it was a distributed allocation so UE-a shares each of those PRBs with another UE, which in the control signal 400 of FIG. 4 can only be UE-d. This is seen at the first, sixth and ninth rows of the distribution examples. Now PRB 3 was also allocated to UE-d as distributed, so the third row of the distribution examples also shows an allocation distributed among UE-a and UE-d. In Example 1 the distribution is timewise; in Example 2 the distribution is according to sub-carrier. However distributed, the exact split of the distributed block is known beforehand and not specifically signaled in the control signal 400.

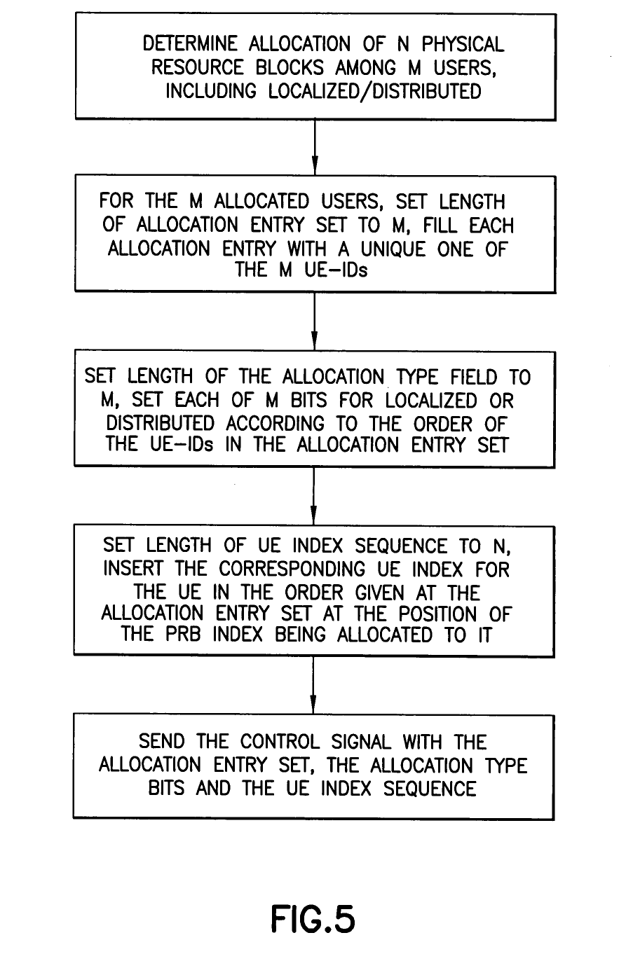

An exemplary method is shown at FIG. 5. At block 502, the allocation of N physical resource blocks among M users is determined, including localized/distributed allocations for those PRBs. At block 504 the length of the allocation entry is set to M, equal to the number of users being allocated. Each allocation entry is filled with a unique one of the M UE-IDs. At block 506, the length of the allocation type field is set to M, and each of M bits is set for localized or distributed according to the order of the UE-IDs in the allocation entry set. At block 508, the length of the UE index sequence is set to N. The PRBs being allocated are arranged in an order that gives an index number to them, and a corresponding UE index for the UE in the order given at the allocation entry set is inserted at the position of the PRB index to which that PRB is being allocated. At block 510 the control signal is sent, with the allocation entry set, the allocation type bits and the UE index sequence such as illustrated in FIGS. 3 and 4. FIG. 5 is also representative of an integrated circuit or other type firmware in which aspects of the invention may be embodied, with the blocks illustrating functional circuitry.

It should be noted that any suitable method to signal the allocation entry information, and the matching of the UEs (UE-IDs) and UE indexes, may be used. Thus, part of the allocation entry information, such as the TFI and HARQ information, may be transmitted on separate UE-specific control channels. Also, at least part of the matching of UEs (UE-IDs) to UE indexes may be signaled on a separate control channel. Such a separately signaled matching may be valid for a number of allocation periods, or may change from allocation period to period. It is also possible that a semi-persistent matching principle is agreed to, where a set of UEs (UE-IDs) are signaled on a separate control channel, and depending on an allocation period identifier (e.g., the SFN), different UEs (UE-IDs) are matched to the UE indexes in a predefined, possibly periodic manner.

An example implementation based on the foregoing is shown in FIG. 3, where M UEs are allocated in a sub-frame with N resource blocks. A more detailed example is shown in FIG. 4.

It is noted that the exemplary embodiments of this invention, may employ any suitable compression technique for the UE index list, the UE IDs themselves, or the allocation entries. Further, the allocation entries may be jointly coded, or coded in multiple parts. As a non-limiting example, those portions of the UE-specific allocation entries that are determinative of transport format, HARQ data, multi-antenna data and so forth may be separately encoded.

As may be appreciated, the use of the exemplary embodiments of this invention provides an enhanced flexibility for making UE 10 resource allocations, while not requiring a burdensome level of overhead signaling and complexity.

Based on the foregoing it should be apparent that the exemplary embodiments of this invention provide a method, apparatus and computer program product(s) to provide a DL control signal for DL resource allocation that comprises allocation entries, allocation type bits and UE index sequence, where an allocation entry comprises a UE-ID for indicating to which UE a corresponding resource is allocated, where an order of the allocation entries indicates a relationship between the UE index and the UE-ID, where individual ones of the allocation type bits corresponds to an individual one of the UE index, and where the allocation type bits indicate whether a corresponding UE is to use localized allocation or distributed allocation. Further in accordance with the exemplary embodiments of method, apparatus and computer program product(s) the UE indexes in the UE index sequence correspond to PRBs and specify which UE(s) use which PRB. For the case of the localized allocation, only one UE uses one PRB, and those PRBs that are used for localized allocation are those that are mapped to UE indexes with the corresponding allocation type bit indicating localized allocation, and a localized VRB of a certain UE index is constructed from the localized PRBs mapped to the certain UE index. For the case of the distributed allocation, multiple UEs may use a given PRB, and the PRB(s) that are used for distributed allocation are those that are mapped to UE indexes with the corresponding allocation type bit indicating distributed allocation, which may be referred to distributed PRBs, and where a distributed VRB of a certain UE index is constructed from all or some of the distributed PRBs that are divided among the distributed VRBs in a pre-determined manner using, for example, one of a cyclic-type distribution or a sub-carrier level distribution. Further in accordance with the exemplary embodiments of method, apparatus and computer program product(s) the distributed VRBs are divided among the distributed UEs in an order that is determined by the order that the indexes of the distributed UEs appear in the UE index sequence.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, or as signaling formats, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof;

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. For instance, although downlink has been primarily described herein, the aspects of the disclosed invention are also suitable for uplink. However, any and all modifications of the exemplary embodiments of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
determining an allocation of N physical resource blocks among M users, including which physical resource blocks are allocated as localized and which are allocated as distributed;
wirelessly sending a control signal that informs the determined allocation, the control signal comprising M allocation entries, allocation type bits and a user index sequence of N user indexes,
where an allocation entry comprises a user identifier for indicating to which user a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation.

2. The method of claim 1, wherein the allocation is for one of downlink resources or uplink resources.

3. The method of claim 1, wherein the user indexes in the user index sequence correspond to physical resource blocks and specify which user or users are allocated which physical resource block.

4. The method of claim 1 wherein at least one physical resource block is allocated as localized to only one user and those physical resource blocks that are used for localized allocation are those that are mapped to user indexes with the corresponding allocation type bit indicating localized allocation.

5. The method of claim 4, wherein a localized virtual resource block of a particular user index is constructed from the localized physical resource blocks mapped to the particular user index.

6. The method of claim 4 wherein at least one physical resource block is allocated as distributed among multiple ones of the user indices having a corresponding allocation type bit that indicates distributed allocation.

7. The method of claim 6, wherein a distributed virtual resource block of a particular user index is constructed from at least some of the distributed physical resource blocks that are divided among the distributed virtual resource blocks in a pre-determined manner, said pre-determined manner not signaled in the control signal.

8. The method of claim 7, wherein the distributed virtual resource blocks are divided among the distributed users in an order that is determined by the order that the indexes of the distributed users appear in the user index sequence.

9. A computer program product, tangibly embodied on a memory, comprising instructions for allocating resource blocks to users, such that when the instructions are executed by a processor the actions comprise:
determining an allocation of N physical resource blocks among M users, including which physical resource blocks are allocated as localized and which are allocated as distributed;
wirelessly sending a control signal that informs the determined allocation, the control signal comprising M allocation entries, allocation type bits and a user index sequence of N user indexes,
where an allocation entry comprises a user identifier for indicating to which user a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation.

10. The computer program product of claim 9, wherein the allocation is for one of downlink resources or uplink resources.

11. The computer program product of claim 9, wherein the user indexes in the user index sequence correspond to physical resource blocks and specify which user or users are allocated which physical resource block.

12. The computer program product of claim 9, wherein at least one physical resource block is allocated as localized to only one user and those physical resource blocks that are used for localized allocation are those that are mapped to user indexes with the corresponding allocation type bit indicating localized allocation.

13. The computer program product of claim 12, wherein a localized virtual resource block of a particular user index is constructed from the localized physical resource blocks mapped to the particular user index.

14. The computer program product of claim 12, wherein at least one physical resource block is allocated as distributed among multiple ones of the user indices having a corresponding allocation type bit that indicates distributed allocation.

15. The computer program product of claim 14, wherein a distributed virtual resource block of a particular user index is constructed from at least some of the distributed physical resource blocks that are divided among the distributed virtual resource blocks in a pre-determined manner, said pre-determined manner not signaled in the control signal.

16. The computer program product of claim 15, wherein the distributed virtual resource blocks are divided among the distributed users in an order that is determined by the order that the indexes of the distributed users appear in the user index sequence.

17. A device comprising:
a memory adapted to stored user identifiers for each of M users;
a processor comprising a packet scheduler function for making an allocation of N physical resource blocks among the M users, including which physical resource blocks are allocated as localized and which are allocated as distributed;
a transceiver, coupled to the processor, adapted to wirelessly send a control signal that informs the allocation, the control signal comprising M allocation entries, allocation type bits and a user index sequence of N user indexes,
where an allocation entry comprises one of the user identifiers for indicating to which user a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation.

18. The device of claim 18, wherein the allocation is for one of downlink resources or uplink resources.

19. The device of claim 18, wherein the user indexes in the user index sequence correspond to physical resource blocks and specify which user or users are allocated which physical resource block.

20. The device of claim 18, wherein at least one physical resource block is allocated as localized to only one user and those physical resource blocks that are used for localized allocation are those that are mapped to user indexes with the corresponding allocation type bit indicating localized allocation.

21. The device of claim 20, wherein a localized virtual resource block of a particular user index is constructed from the localized physical resource blocks mapped to the particular user index.

22. The device of claim 20, wherein at least one physical resource block is allocated as distributed among multiple ones of the user indices having a corresponding allocation type bit that indicates distributed allocation.

23. The device of claim 22, wherein a distributed virtual resource block of a particular user index is constructed from at least some of the distributed physical resource blocks that are divided among the distributed virtual resource blocks in a pre-determined manner, said pre-determined manner not signaled in the control signal.

24. The device of claim 23, wherein the distributed virtual resource blocks are divided among the distributed users in an order that is determined by the order that the indexes of the distributed users appear in the user index sequence.

25. A device comprising:
means for determining an allocation of N physical resource blocks among M users, including which physical resource blocks are allocated as localized and which are allocated as distributed;
means for wirelessly sending or receiving a control signal that informs the determined allocation, the control signal comprising M allocation entries, allocation type bits and a user index sequence of N user indexes,
where an allocation entry comprises a user identifier for indicating to which user a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation.

26. The device of claim 25 comprising a Node B, wherein:
the means for determining comprises a processor comprising a packet scheduler function coupled to a memory; and
the means for wirelessly sending or receiving comprises a transceiver for wirelessly sending the control signal.

27. The device of claim 25 comprising a user equipment, wherein:
the means for wirelessly sending or receiving comprises a transceiver for wirelessly receiving the control signal; and
the means for determining comprises a processor coupled to a memory that stores a user identity temporarily assigned to the user equipment and a table of physical resource blocks associated with indexes, the processor adapted to:
determine from the control signal and the memory each physical resource block allocated to the user equipment and whether the allocated physical resource block is localized or distributed; and
control the transceiver to transmit over the physical resource block allocated to the user equipment for the case where the control signal comprises an uplink allocation, or to control the transceiver to receive over the physical resource block allocated to the user equipment for the case where the control signal comprises a downlink allocation.

28. An integrated circuit comprising:
circuitry adapted to determine an allocation of N physical resource blocks among M users, including which physical resource blocks are allocated as localized and which are allocated as distributed;
circuitry adapted to arrange and to wirelessly send a control signal that informs the determined allocation, the control signal comprising M allocation entries, allocation type bits and a user index sequence of N user indexes;
where an allocation entry comprises a user identifier for indicating to which user a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation.

29. The integrated circuit of claim 28, wherein the user indexes in the user index sequence correspond to physical resource blocks and specify which user or users are allocated which physical resource block.

30. The integrated circuit of claim 28, wherein at least one physical resource block is allocated as localized to only one user and those physical resource blocks that are used for localized allocation are those that are mapped to user indexes with the corresponding allocation type bit indicating localized allocation.

31. The integrated circuit of claim 30, wherein a localized virtual resource block of a particular user index is constructed from the localized physical resource blocks mapped to the particular user index.

32. The integrated circuit of claim 30, wherein at least one physical resource block is allocated as distributed among multiple ones of the user indices having a corresponding allocation type bit that indicates distributed allocation.

33. The integrated circuit of claim 32, wherein a distributed virtual resource block of a particular user index is constructed from at least some of the distributed physical resource blocks that are divided among the distributed virtual resource blocks in a pre-determined manner, said pre-determined manner not signaled in the control signal.

34. The integrated circuit of claim 33, wherein the distributed virtual resource blocks are divided among the distributed users in an order that is determined by the order that the indexes of the distributed users appear in the user index sequence.

35. A system comprising a network element and a plurality of M user equipments, wherein the network element comprises:
a memory adapted to stored user identifiers for each of the M user equipments;
a processor comprising a packet scheduler function for making an allocation of N physical resource blocks among the M user equipments, including which physical resource blocks are allocated as localized and which are allocated as distributed; and
a transceiver, coupled to the processor, adapted to wirelessly send a control signal to the M user equipments that informs the allocation, the control signal comprising M allocation entries, allocation type bits and a user index sequence of N user indexes, where N and M are each integers greater than one and N is equal to or greater than M,
where each allocation entry comprises one of the user identifiers for indicating to which user equipment a corresponding resource is allocated;
where an order of the allocation entries indicates a relationship between the user index and the user identifier;
where individual ones of the allocation type bits corresponds to an individual one of the user index;
and where the allocation type bits indicate whether a corresponding user is to use localized allocation or distributed allocation;
and wherein each of the M user equipments comprise:
a memory adapted to store an Mth user identifier assigned to the user equipment;
a transceiver adapted to wirelessly receive the control signal; and
a processor adapted to determine from the control signal the allocation for the Mth user equipment, including a resource allocated to the Mth user equipment and whether the resource allocated is localized or distributed, the processor further adapted to control the transceiver to monitor the resource allocated to the Mth user equipment for the case where the resource allocation is a downlink allocation, and to transmit on the resource allocated to the Mth user equipment for the case where the resource allocation is an uplink allocation.
